(19) United States
(12) Patent Application Publication
(10) Pub. No.: US 2020/0078931 A1
(43) Pub. Date: Mar. 12, 2020

(54) Reflective Work Mat

(71) Applicant: Rene Folse, Ponchatoula, LA (US)

(72) Inventor: Rene Folse, Ponchatoula, LA (US)

(21) Appl. No.: 16/128,051

(22) Filed: Sep. 11, 2018

(51) Int. Cl. B25H 5/00; A47G 27/02

(52) U.S. Cl. CPC B25H 5/00; B32B 2471/04; B32B 2307/416; A47G 27/0212

(57) ABSTRACT

A reflective work mat for padding and illumination includes a pad having a width, a length, a thickness, a top side, and a bottom side. A reflective layer is continuously disposed on the top side of the pad. The reflective work mat is configured to be placed partially underneath a dark work space, such as an automobile undercarriage, with the reflective layer facing upwards to reflect light and illuminate the dark work space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to work mats and more particularly pertains to a new work mat for padding and illumination.

### BRIEF SUMMARY OF THE INVENTION

An embodiment of the disclosure meets the needs presented above by generally comprising a pad having a width, a length, a thickness, a top side, and a bottom side. A reflective layer is continuously disposed on the top side of the pad. The reflective work mat is configured to be placed partially underneath a dark work space, such as an automobile undercarriage, with the reflective layer facing upwards to reflect light and illuminate the dark work space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a reflective work mat according to an embodiment of the disclosure.

FIG. 2 is an in-use side elevation view of an embodiment of the disclosure.

FIG. 3 is a bottom plan view of an embodiment of the disclosure.

FIG. 4 is a cross-sectional view of an embodiment of the disclosure along line 4-4 of FIG. 3.

### DETAILED DESCRIPTION OF THE INVENTION

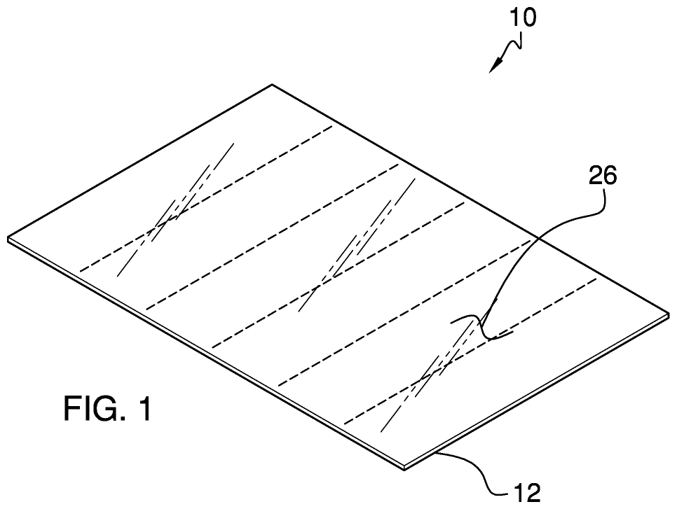

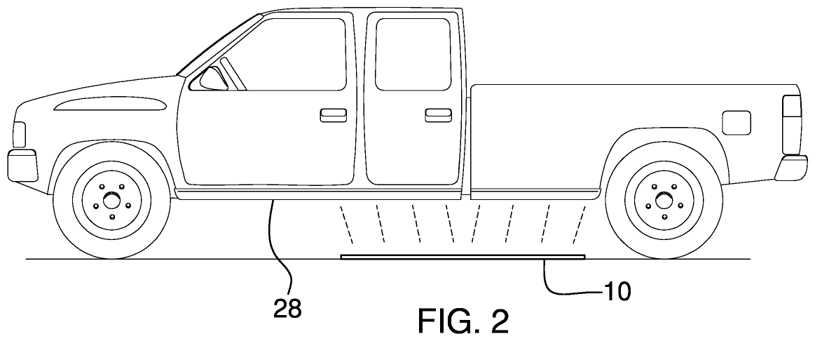

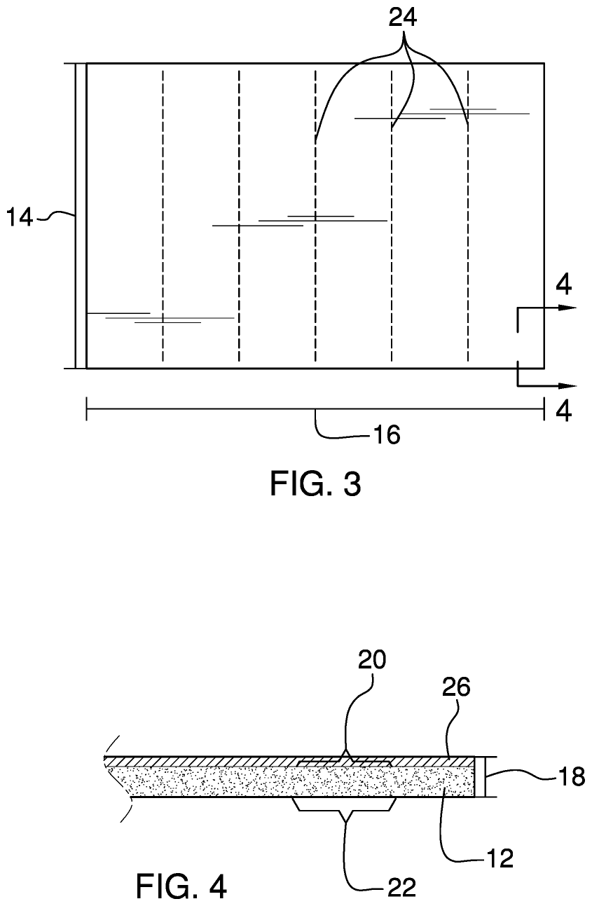

With reference now to the drawings, and in particular to FIGS. 1 through 4 thereof, a new work mat embodying the principles and concepts of an embodiment of the disclosure and generally designated by the reference numeral 10 will be described.

As best illustrated in FIGS. 1 through 4, the reflective work mat 10 generally comprises a pad 12 having a width 14, a length 16, a thickness 18, a top side 20, and a bottom side 22. The thickness may be between 0.30 to 2.54 centimeters, the width may be at least 1.2 meters, and the length may be at least 1.8 meters. The pad may be a cushioned material that is moisture and oil resistant to improve longevity and easy of cleaning. The pad may have a plurality of fold lines 24 and fold over each of the plurality of fold lines for storage. Alternatively, the pad may be rollable. A reflective layer 26 is continuously disposed on the top side of the pad. The reflective layer may also be moisture and oil resistant. The reflective layer may be smooth, dimpled, crinkled, or otherwise textured.

In use, wherein the reflective work mat is configured to be placed partially underneath a dark work space, such as an automobile undercarriage 28, with the reflective layer facing upwards to reflect light and illuminate the dark work space. At least 30 centimeters of pad should remain exposed from the vehicle to catch light. A user may then lie on the pad for cushioning while working underneath the vehicle without needing an artificial light source.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A reflective work mat comprising:
a pad having a width, a length, a thickness, a top side, and a bottom side; and
a reflective layer coupled to the pad, the reflective layer being continuously disposed on the top side;
wherein the reflective work mat is configured to be placed partially underneath a dark work space, such as an automobile undercarriage, with the reflective layer facing upwards to reflect light and illuminate the dark work space.

2. The reflective work mat of claim 1, further comprising the pad having a plurality of fold lines, the pad folding over each of the plurality of fold lines.

3. The reflective work mat of claim 1, further comprising the pad being a cushioned material and the thickness being between 0.30 to 2.54 centimeters.

4. The reflective work mat of claim 3, further comprising the width of the pad being at least 1.2 meters and the length being at least 1.8 meters.

5. The reflective work mat of claim 2, further comprising each of the pad and the reflective layer being moisture and oil resistant.

6. A reflective work mat comprising:
a pad having a width, a length, a thickness, a top side, and a bottom side, the thickness being between 0.30 to 2.54 centimeters, the width being at least 1.2 meters and the length being at least 1.8 meters, the pad being a cushioned material that is moisture and oil resistant, the pad having a plurality of fold lines, the pad folding over each of the plurality of fold lines; and
a reflective layer coupled to the pad, the reflective layer being continuously disposed on the top side, the reflective layer being moisture and oil resistant;
wherein the reflective work mat is configured to be placed partially underneath a dark work space, such as an automobile undercarriage, with the reflective layer facing upwards to reflect light and illuminate the dark work space.
